(19) United States
(12) Patent Application Publication
(10) Pub. No.: US 2025/0172907 A1
(43) Pub. Date: May 29, 2025

(54) BINARY PATTERN TRANSFORMATION DISPLAY

(71) Applicant: Sony Interactive Entertainment Inc., Tokyo (JP)

(72) Inventor: Jeffrey R. Stafford, Redwood City, CA (US)

(21) Appl. No.: 18/520,329

(22) Filed: Nov. 27, 2023

(51) Int. Cl. G03H 1/22; G02F 1/13; G03H 1/08; H04N 13/351

(52) U.S. Cl. CPC G03H 1/2294; G02F 1/1323; G03H 1/0808; H04N 13/351

(57) ABSTRACT

A display device includes a display array comprising a plurality of binary pixels, each binary pixel comprises at least one light source with two light source modulating pixels configured to form three or more binary patterns. A device further includes a first layer above the at least two light source modulating pixels, the first layer comprises a light diffraction material across the binary pixel, wherein the light diffraction material is configured to cause a first modification of a first binary pattern to output a first light, cause a second modification of a second binary pattern to output a second light, and cause a third modification of a third binary pattern to output a third light, wherein the first, second and third output light have substantially different visual characteristics.

### BACKGROUND OF THE INVENTION

### Field of the Invention

Embodiments of the present invention relate generally to display devices and specifically to a display device that performs binary pattern transformation.

### Background

Computer-generated holograms (CGH) displayed or projected via holographic displays and projectors are a desirable future display solution, as they have the potential to produce more natural-looking images than traditional display technologies. Holographic displays and projectors can provide more natural focal and parallax cues, which can increase realism and reduce the side effects (e.g., vergence-accommodation conflict issue) of viewing stereoscopic three dimensional (3D) images.

### BRIEF DESCRIPTION OF DRAWINGS

The above and other aspects, features and advantages of embodiments of the present invention will be more apparent from the following more particular description thereof, presented in conjunction with the following drawings wherein:

FIG. 1 is an illustration of the layout of a binary pixel of a display device according to some embodiments;

FIG. 2 is an illustration of a portion of a display device according to some embodiments;

FIGS. 3A and 3B include illustrations of binary pattern transformations according to some embodiments;

FIG. 4 is a block diagram illustrating a system that includes a processor-based system or apparatus that may be used to run, implement, and/or execute many of the methods, schemes, and techniques shown and described herein in accordance with some embodiments of the present invention;

FIG. 5 is a flow diagram illustrating a method in accordance with some embodiments of the present invention; and

FIG. 6 is a flow diagram illustrating another method in accordance with some embodiments of the present invention.

### DETAILED DESCRIPTION

CGH generally requires a significant amount of computation to calculate the images to be displayed on holographic displays and projectors. These computations typically involve many Fourier transforms, which are expensive for digital computing systems. Many attempts have been made to reduce the computational load of CGH, including utilizing deep learning neural networks. But even so, CGH computation remains a significant challenge to computing cost, latency, power, and thermal mitigation requirements.

In addition, holographic displays and projectors that use spatial light modulation to diffract light require extremely small pixels to achieve acceptable fields of view. This is due to the diffraction effect, which has the inverse relationship between pixel size and field of view. As diffractive pixel elements become smaller, the diffraction angle range increases. Ideally, holographic displays and projectors would use pixels just slightly smaller than the wavelengths of visible light, under 0.8 microns (800 nanometers). However, few display technologies can support active pixels less than 3 microns (3000 nanometers) and the current commercially available displays usually have pixel sizes in the 10 s-100 s of microns. Conversely, as displays shrink due to smaller pixels, their total area of emission shrinks, unless their resolution increases significantly. For XR applications (VR and AR), smaller displays with smaller emission areas, lead to a reduction in the viewable eye box and the need for increasingly more powerful and complex magnification optics, or challenging strategies like exit pupil expansion.

In some embodiments, the systems and methods described herein provide a display device that addresses computational load, power usage, thermals, pixel size, and emission area/eyebox issues of a CGH display.

One approach for reducing the computational load of CGH is to precompute the holograms and use a lookup table to retrieve the previously computed holograms. For a digital computer, even using an efficient memory scheme, this task can still involve significant amounts of computer memory, latency, power, and produce significant heat. In some embodiments, the systems and methods described herein move the problem from the digital computing domain to the optical domain, by incorporating the lookup aspect directly into the light emission pipeline.

In some embodiments, a display device is provided comprising a display array including a plurality of binary pixels, each binary pixel comprises at least one light source and two light source modulating pixels configured to form three or more binary patterns, a first layer above the at least two source pixels, the first layer comprises a light diffraction material having variable refractive index across the binary pixel. The light diffraction material is configured to cause a first modification of a first binary pattern to output a first light, and cause a second modification of a second binary pattern to output a second light; and output, in response to a third binary pattern, a third light being a combination of the first source pixel and the second source pixel, wherein the light from the first source pixel and the light from the second source pixel are combined using holographic interference principles, such that the third output light has different visual characteristics from the first output light and the second output light.

In some embodiments, a method is provided comprising establishing a layer comprising a light diffraction material having variable refractive index, using the layer to create a first output light by causing a first modification of a first binary pattern formed by at least two source pixels, using the layer to create a second output light by causing a second modification of a second binary pattern formed by the at least two source pixels, and using the layer to create a third output light comprising a combination of the first source pixel and the second source pixel in response to a third binary pattern formed by the at least those two source pixels, wherein the light from the first source pixel and the light from the second source pixels are combined using holographic interference principles, such that the third output light has different visual characteristics from the first output light and the second output light.

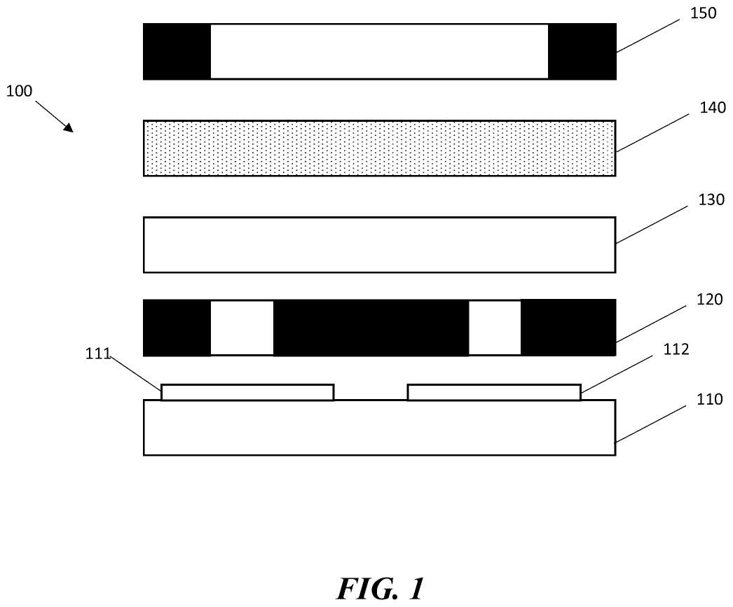

Referring now to the drawings, FIG. 1 illustrates the layout of a binary pixel 100 of a binary pattern transformation display in accordance with an embodiment of the present invention. In some embodiments, a binary pattern transformation display described herein includes a light source array 110 and one or more transformation layers 130. The light source array 110 may comprise shared light source emitting display technology with pixel based light source modulation (e.g., amplitude and/or phase modulation), such as a backlit light-emitting diode (LED) (e.g., including Micro LED (uLED), LED on Silicon) illuminated liquid crystal display (LCD), a LED illuminated digital micromirror device (DMD) display, a LED illuminated digital light processing (DLP) device display, a LED illuminated liquid crystal on silicon (LCOS) device display, a LED illuminated ferroelectric liquid crystal on silicon (FLCOS) device display, a laser illuminated (e.g., including vertical-cavity surface-emitting lasers (VCELs)) LCD, or DMD, or DLP, or LCOS, or FLCOS display, an organic LED (OLED) display (e.g., including Micro OLED, OLED on Silicon) illuminated LCD, or DMD, or DLP, or LCOS, or FLCOS display, or other display technologies where a display light source is shared and modulated by at least two pixels. The light source array 110 includes one light source for two or more light source modulating pixels 111 and 112, herein to be referred to as source pixels 111 and 112 within a binary pixel 100. In some embodiments, source pixels 111 and 112 within a binary pixel 100 may emit the same or similar light color (e.g., red, green, or blue). In some embodiments, the source pixels 111 and 112 may emit light having differing wavelengths, as their light may optionally pass through a color/wavelength filter. In some embodiments, the source pixels 111 and 112 may include a change in light wavelength through their modulation. In some embodiments, source pixels 111 and 112 may perform only phase-based modulation, or only amplitude-based modulation. In some embodiments, source pixels 111 and 112 modulation is binary between off and on states. In some embodiments, source pixels 111 and 112 modulation is between many states (i.e., grey scale modulation), for example between 0 and 255 states (i.e., 8-bit modulation). While two source pixels are shown in the light source array 110, In some embodiments, a binary pixel 100 may include three, four, five or more source pixels.

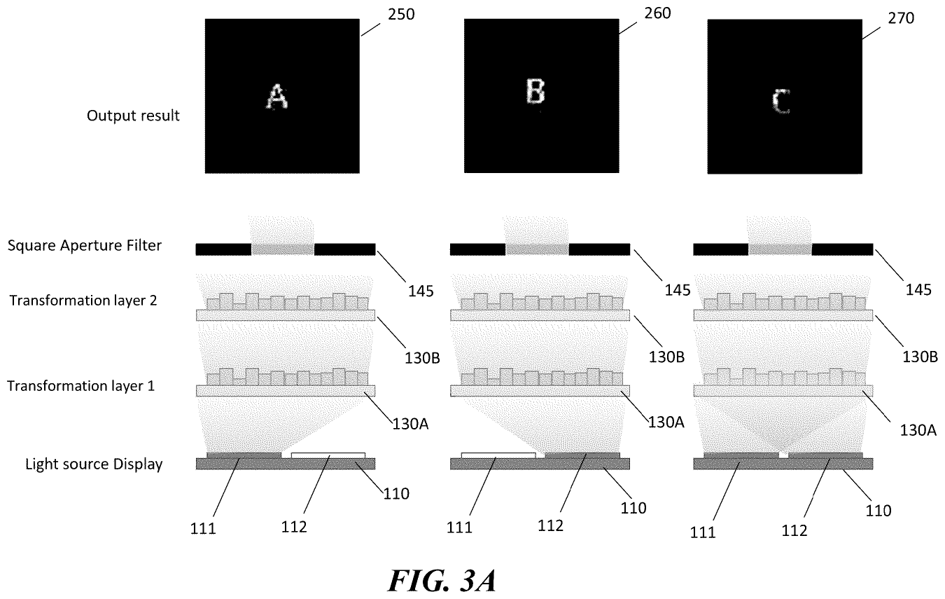

In some embodiments, the one or more transformation layers 130 may comprise one or more layers of material configured to cause light diffraction, including changes in phase and/or amplitude. In some embodiments, the transformation layer may include variable-thickness plastic, glass, or other significantly transparent material for phase modulation. In some embodiments, the one or more transformation layers 130 may include two or more regions of different thicknesses configured to cause different phase-base diffraction. In some embodiments, the one or more transformation layers 130 may include a variable-sized aperture patterned mask configured to cause amplitude modulation. In some embodiments, the one or more transformation layers 130 may include a volume hologram material configured to cause different phase modulation and/or amplitude modulation. In some embodiments, the one or more transformation layers 130 may include multiple layers each configured to perform a different set of visual characteristic transformations. In some embodiments, the transformation may comprise a change in one or more of light direction, focal point, intensity profile, phase profile, image formation, and/or polarization. In some embodiments, the transformation layers 130 may use a light diffraction material that is reflective instead of transmissive, which optionally combined with beam splitters, and/or polarizers, and/or polarized filters, and/or other optical components could provide a system like the transparent system described herein. Further details of the transparent transformation layer 130 are described with reference to FIGS. 3A and 3B herein, but it should be understood the same details could be applied to a system with reflective transformation layers.

In some embodiments, the display may optionally include a beam shaping layer 120 between the source pixels and the transformation layers 130. In some embodiments, the beam shaping layer 120 may include aperture masks such as square or circular holes over each light source pixel element (e.g., source pixel 111 and source pixel 112) acting as pinholes. In some embodiments, the beam shaping layer 120 may additionally or exclusively include a micro lens array with a micro lens over each source pixel element. In some embodiments, the beam shaping layer 120 may additionally or exclusively include patterned diffraction gratings, such as, but not limited to, a blazed grating, to alter light from source pixel 111 and source pixel 112 to increase the effectiveness of the transformation layers 130. Wherein, the diffraction grating may be different per source pixel, such that a diffraction effect on source pixel 111 is significantly different from the diffraction effect on source pixel 112.

In some embodiments, the display may optionally include a attenuation layer 140 above the one or more, or between two or more transformation layers 130. The attenuation layer 140 may comprise a material configured to dampen/reduce/change the light passing through the layer in a linear or non-linear way. In some embodiments, the attenuation layer 140 may be semi-transparent and include a neutral density filter. In some embodiments, the attenuation layer 140 may be implemented by a wavelength conversion material, that converts (down-converts or up-converts) light from one wavelength to another (i.e., from invisible Infrared to visible red). Wherein, the act of wavelength conversion would also attenuate the light. It should be understood, that using a wavelength conversion and attenuation layer 140, the light source array 110 may output a wavelength of light that is significantly different from at least the first, second and third output light that exits the system. In some embodiments, the wavelength conversion and/or attenuation layer 140 may be patterned, instead of uniform across the binary pixel, wherein one or more regions of the layer 140 may have differing wavelength conversion and/or attenuation. Such a system may enable further differing visual characteristics between at least the first, second and third output light, such as differing wavelength (i.e., first output light is red, second output light is green, and third output light is blue).

In some embodiments, the display may optionally include an aperture layer 150. The aperture layer 150 may include an open aperture section (i.e., transparent or substantially transparent) and a closed aperture section (i.e., opaque or substantially opaque) configured to block light around the peripheral edges of a binary pixel 100.

While spaces are shown between layers of the binary pixel 100 in FIG. 1, In some embodiments, one or more of the light source array 110, the beam shaping layer 120, the one or more transformation layers 130, the attenuation layer 140, and the aperture layer 150 may directly contact one or more adjacent layers or be bounded to each other via a bounding layer such as an adhesive. In some embodiments, two or more of these layers may be incorporated together into one layer.

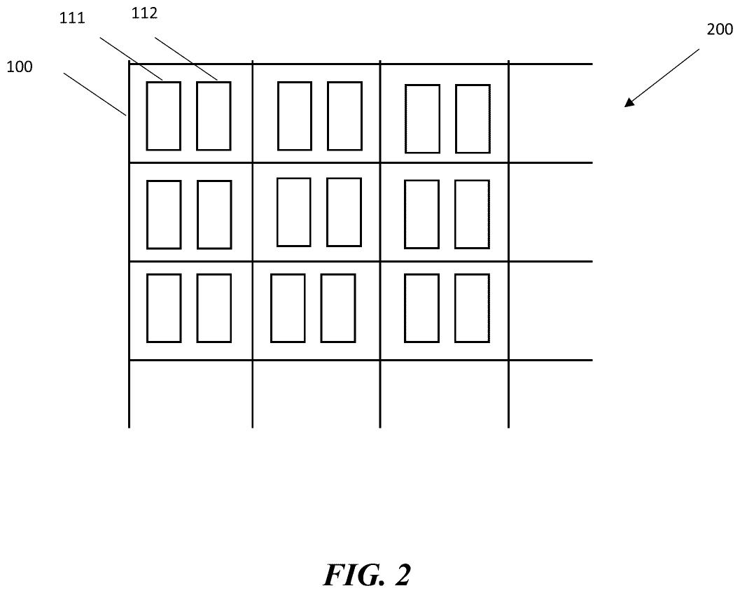

Next referring to FIG. 2, a top-down view of a portion of a display device 200 for binary pattern transformation is shown. In some embodiments, the display device 200 may comprise a display screen, a projector display, or a beam-scanning display. The display device 200 includes a plurality of binary pixels 100 such as the binary pixel 100 described with reference to FIG. 1. Each binary pixel 100 includes two or more source pixels 111 and 112. In some embodiments, a binary pixel may include three or more source pixels. The one or more transformation layers 130, and optionally, the beam shaping layer 120, the attenuation layer 140, and the aperture layer 150 described with reference to FIG. 1 may be situated between the source pixels 111 and 112 and a viewer of the display device. In some embodiments, the beam shaping layer 120, the one or more transformation layers 130, the attenuation layer 140, and/or the aperture layer 150 may be shared and continuous over two or more binary pixels. For example, the one or more transformation layers 130 may be a single sheet of material covering the binary pixels 100 of the display device 200. In some embodiments, a binary pixel 100 may be formed by grouping adjacent same-color source pixels from two or more conventional tri-color (e.g., RGB) pixels. For example, source pixels from adjacent two conventional tri-color pixels may form a 2-bit blue binary pixel, a 2-bit green binary pixel, and a 2-bit red binary pixel.

As described herein, the binary pattern formed by the source pixel groups within each binary pixel 100 may be differently transformed by the one or more transformation layers 130 to have different visual characteristics. Accordingly, the display device 200 is configured to display an image with virtual pixels of different visual characteristics designated via the binary patterns. FIG. 2 only illustrates a portion of the display device 200. It is understood that the display may comprise any number of binary pixels such as equivalent to a 720p display, 1080p display, 1440p display, 4k display, 8k display, etc.

In some embodiments, the display device 200 is configured to display images using the light from the light source array 110 and the one or more transformation layers 130 to perform an optical lookup. In some embodiments, the one or more transformation layers 130 are configured to use diffraction and generate a holographic image as output by manipulating one or more optical properties of the light such as shape, size, image formation, intensity, focal distance (e.g., distance from one or more transformation layers 130 to where the output virtual pixel of light is in focus/smallest spot size), emission angle (e.g., Azimuth and Pitch of the primary emission of the output virtual pixel light), and/or polarization state. In some embodiments, the transformation layer may also be referred to as a diffraction layer. In some embodiments, the one or more transformation layers 130 of some binary pixels may output parallel beams of light, with minimal beam convergence or divergence.

The source pixels within a binary pixel 100 are configured to form binary selection patterns to illuminate the one or more transformation layers 130. For example, a 2-bit binary pattern transformation display would use 2 source pixels to represent a 2-bit (base-2 numeral system) binary input, producing a pixel input number of 1 (1st pixel ON, 2nd pixel OFF), 2 (1^{st}Pixel OFF, 2nd pixel ON) or 3 (both pixels ON). The binary pixel input to the transformation layers would optically select the pre-recorded output. For the 2-bit binary transformation display, 3 different 2-bit patterns (ON/OFF, OFF/ON, ON/ON) could be used to select between 3 different pre-recorded holographic outputs. In some embodiments, the transformation layers of diffractive material would form an optical diffractive neural network, performing a mostly linear transformation from the input source pixels to the output virtual pixels.

In some embodiments, input source pixels are much larger than diffractive pixels of the one or more transformation layers 130 to maintain sufficient illumination from input to output through multiple diffractive layers, a square aperture filter, a neutral density filter, and any other layers. In some embodiments, the binary pattern transformation display may use current display technologies as light sources, which typically have pixels with sizes ranging from the 10's of microns to 100's of microns. In some embodiments, the one or more transformation layers 130 may have diffractive pixels at between 100 nanometers to 1000 nanometers (1 micron). The input light from the source pixels may cover 10-100× more area than diffractive pixels of the one or more transformation layers 130.

In some embodiments, the system may be used to pre-record holograms into passive plastic transformation layers to change the focal distance of a pixel's light emission based on the light source as a simplified holographic display. For example, for the 2-bit binary pattern transformation display, three focal distances per virtual pixel could be pre-recorded and played back based on the source image sent to the display source (e.g., LCD). Therefore, the computation compared to a traditional CGH display could be significantly reduced. In some embodiments, a single diffractive phase layer could enable a 2-BIT binary pattern transformation display. In some embodiments, two or more diffractive layers may be used as shown in FIG. 3A.

In some embodiments, the binary transformation display may be scaled to handle a 3-bit, 4-bit, 5-bit, etc. binary pixel display, then its functional output increases to 7 unique outputs, 15 unique outputs, 31 unique outputs per virtual pixel respectively. In some embodiments, additional transformation layers may be used for 3-bit and above. Also, additional non-linear layers (such as attenuation and/or wavelength conversion layers) may be used to enhance transformation from input binary patterns to fixed outputs. In some embodiments, the transformation layer allows the control of the focal length, emission angle, shape/size, image formation, and/or polarization of a output virtual pixel, while the intensity of the output virtual pixel is governed by the brightness of the light source (i.e., light source array 110 from FIG. 1) and/or the light source pixel modulation effect (i.e., from source pixels 111 and 112 from FIG. 1). In some embodiments, the transformation layer may also encode different levels of output virtual pixel intensity.

Next referring to FIGS. 3A and 3B, illustrations of transformations by a 2-bit binary pattern transformation display are shown. The display shown in FIG. 3A includes a light source array 110 having a first source pixel 111 and a second source pixel 112, a first transformation layer 130A, a second transformation layer 130B, and a square aperture and neutral density filter layer 145, which is a combination of the semi-transparent attenuation layer 140 and the aperture layer 150 from FIG. 1.

The display device is formed such that light from the light source array 110 passes through source pixels 111 and 112, then the first transformation layer 130A which causes a first modification of the light characteristics, then passes through the second transformation layer 130B, which causes a secondary modification of the light. In some embodiments, the transformation layers 130A and the transformation layers 130B are configured to cause primary and secondary diffractions.

When the first source pixel 111 is on and the second source pixel 112 is off, forming a first binary pattern 310, the transformation layers 130A and 130B output a first light 315, presenting as letter “A”. In the first light 315, a faint letter “C” is present as encoded into the transformation layers. The aperture and neutral density filter layer 145 reduces the noise in the first output light 315, removing the faint “C” to display a first output light 250 with a clear “A”. When the first source pixel 111 is off and the second source pixel 112 is on, forming a second binary pattern 320, the transformation layers 130A and 130B outputs a second light 325, presenting as the letter “B.” In the second output light 325, a faint letter “C” is also present as encoded into the transformation layers. The aperture and neutral density filter layer 145 reduces the noise in the second output light 325, removing the faint “C”, to display a second output light 260 with a clear “B”. When the first source pixel 111 and the second source pixel 112 are both on, forming a third binary pattern 330, the transformation layers 130A and 130B outputs a third light 335, presenting as the letter “C.” The third output light 335 may be formed by the combination and/or interference pattern of the first output light 315 and the second output light 325 and includes faint letters “A” and “B.” The aperture and neutral density filter layer 145 reduces noise of the image into the third output light 270, removing the faint “A” and “B,” to output a clear “C”. While in FIGS. 3A and 3B, letters are used to represent visual characteristics, the first output light 250, the second output light 260, and the third output light 270 may represent virtual pixels (i.e., small dots of light) that differ in one or more of focal length, emission angle, shape/size, image formation, polarization, and/or intensity in various embodiments.

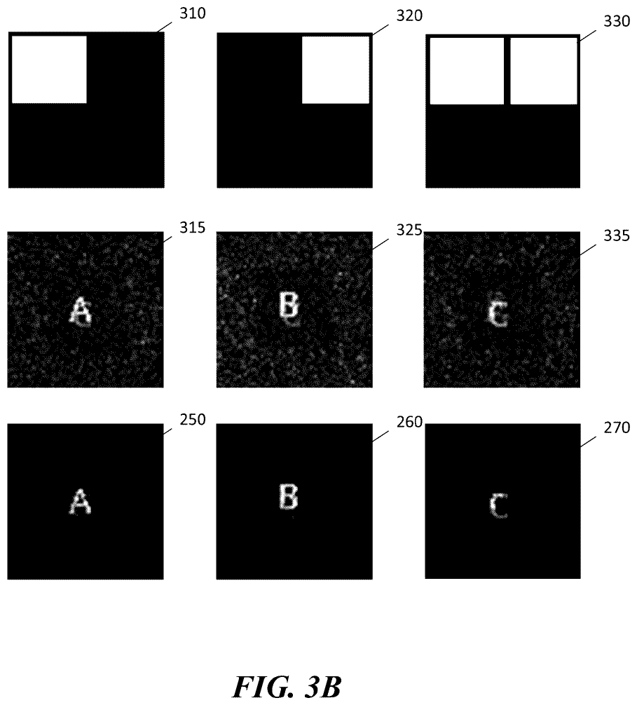

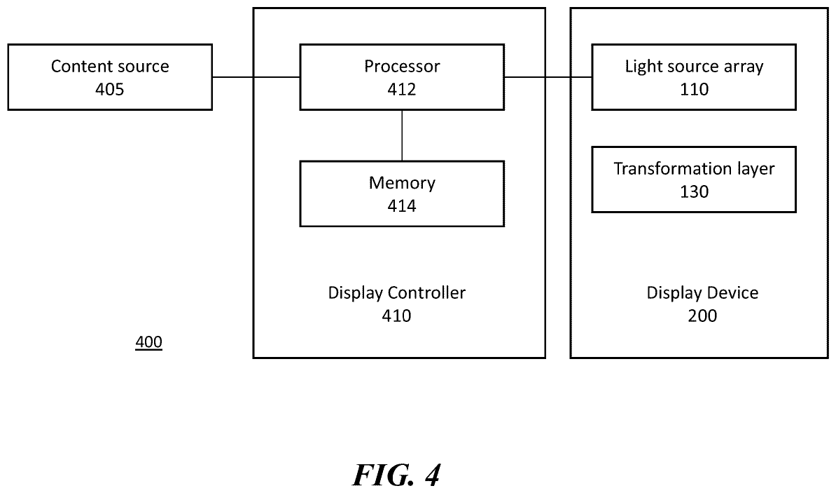

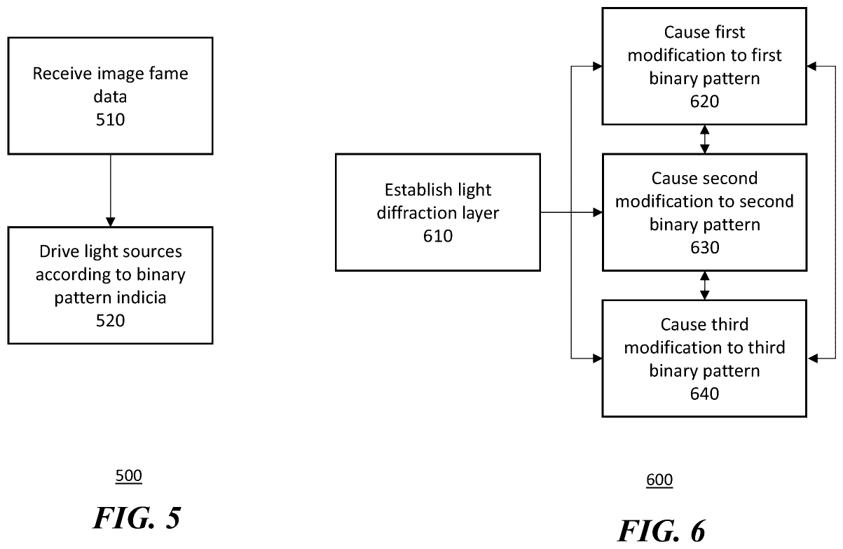

FIG. 4 illustrates a system 400 in accordance with some embodiments of the present invention. In some embodiments, the display controller 410, the display device 200, or the entire system 400, may be used for implementing, executing, or practicing many of the methods, schemes, techniques, systems, or devices described herein. The system 400, which in some embodiments, may be configured to execute one or more steps described with reference to FIGS. 5 and 6.

In some embodiments, the display device 200 includes a light source array 110 and one or more transformation layers 130. In some embodiments, the display device 200 may further include other components such as beam shaping layer 120, semi-transparent attenuation layer 140, and aperture layer 150 described with reference to FIGS. 1 and 3A herein. In some embodiments, the display device 200 includes a plurality of binary pixels 100 as described with reference to FIGS. 1 and 2 herein.

In some embodiments, the display controller 410 includes a processor 412 (e.g., a central processing unit (CPU)), a memory 414, and a wireless and/or wired connection with a content source 405. In some embodiments, the components communicate with each other via connections and/or communications channels, which may comprise wired connections, wireless connections, network connections, or a mixture or combination of both wired and wireless connections, communications channels, network connections, buses, etc. In some embodiments, the display controller 410 may comprise a computer, desktop computer, notebook computer, workstation, server, portable device, mobile device, pad-like device, smartphone, entertainment system, game console, gaming computer, etc. In some embodiments, the display controller 410 may comprise a display device control circuit such as an application-specific control circuit (ASIC) integrated into a binary pattern transformation display device such as the display device 200.

The processor 412 may be used to execute or assist in executing the steps of the methods, schemes, and techniques described herein. For example, in some embodiments, the processor 412 executes code, software, or steps that implements, carries out, and/or facilitates the control of the display device 200. Particularly, the display controller 410 may be configured to drive the binary patterns formed by binary pixels of the light source array 110 based on content received from the content source 405. In some embodiments, the content source 405 may be a computer readable memory device, a network streaming service, a media storage reader, and the like. In some embodiments, the content source 405 provides content data that associates a binary pattern indicia with each pixel of each frame. The display controller 410 is then configured to drive the display device 200 based on the binary pattern indicia in the content data. In some embodiments, the display controller 410 may be configured to perform simplified CGH processing based on 3D model data or depth map data provided by the content source 405 to determine the binary pattern indicia for each binary pixel in each frame for display. In some embodiments, the input image includes pixels that are the quantized depth value binary patterns attenuated by the intensity of the pixel for each red, green, and blue to provide a full-color multi-focal image display.

The memory 414 may include or comprise any type of computer readable storage or recording medium or media. In some embodiments, the memory 414 may include or comprise a tangible, physical memory. In some embodiments, the memory 414 may be used for storing program or computer code or macros that implement the methods and techniques described herein, such as program code for running the methods, schemes, and techniques described herein. In some embodiments, the memory 414 may serve as a tangible non-transitory computer readable storage medium for storing or embodying one or more computer programs or software applications for causing a processor-based apparatus or system to execute or perform the steps of any of the methods, code, schemes, and/or techniques described herein. Furthermore, in some embodiments, the memory 414 may be used for storing any needed database(s) such as a binary pattern lookup table. In some embodiments, the content received from the content source 405 may be stored or partially stored in the memory 414.

Next referring to FIG. 5, a method for driving a binary pattern transformation device is shown. In some embodiments, the method 500 is executed by a processor-based system or apparatus, such as the system 400.

In step 510, image frame data is received from a content source. In some embodiments, the image frame data may include a red, green, blue color value, a depth value or binary pattern indicia associated with each expected virtual pixel in the frame. In some embodiments, a display controller 410 may be configured to convert and/or quantize color and/or depth values to binary pattern indicia based on one or more lookup tables, calculation, or algorithm.

In step 520, the system drives the light sources of the display device according to the binary pattern indicia for each binary pixel in the image frame data. The binary patterns would then cause the designated transformation to be performed via the transformation layer of the display device to output a virtual image.

Next referring to FIG. 6, a method for displaying an image via a binary pattern transformation device is shown. In some embodiments, the method 600 is executed by a processor-based system or apparatus, such as the system 400.

In step 610, a light diffraction layer such as the transformation layer 130 is established in a display device such as the display device 200. The display may be operated to project different binary patterns in each binary pixel. Depending on the projected binary pattern, the display may cause a first modification to a first binary pattern projected from light sources of a binary pixel in step 620, cause a second modification to a second binary pattern projected from the light sources of the binary pixel in step 630, and/or cause a third modification to a third binary pattern projected from the light sources of the binary pixel in step 640. As the display device displays different images, the process may move between steps 620, 630, and 640 to output light modified to have one of the three designated virtual characteristics encoded into the one or more transformation layers of the display. In some embodiments, each binary pixel in a display device may be driven separately through a similar process.

In some embodiments, the first binary pattern comprises the first light source being turned on and the remaining light sources of the light source array being turned off. In some embodiments, the second binary pattern comprises a second light source of the light source array being turned on and the remaining light sources being turned off. In some embodiments, the third binary pattern comprises both the first light source and the second light source being turned on.

In some embodiments, the output of steps 620, 630, and 640 may each have a different visual characteristic such as variations in one or more of focal length, emission angle, shape/size, image formation, polarization, and/or intensity. For example, the light output of step 620 may have a short focal length, the light output of the step 630 may have a medium focal length, and the light output of the step 630 may have a long focal length. In another example, the light output of step 620 may have a first phase shift, the light output of step 630 may have a second phase shift, and the light output of step 640 may have a third phase shift. While a 2-bit binary pattern transformation display with three modifications of three binary patterns is described with reference to the method in FIG. 6, a similar method may be performed for 3-bit, 4-bit, or more binary pattern transformation displays.

In some embodiments, the binary pattern transformation systems and methods described herein are configured to increase computational efficiency. In some embodiments, the display provides a light-shaping function using a quantized binary representation to represent a number to select between certain pre-recorded virtual pixel output. In some embodiments, the Fourier transform computation can be omitted and little or no computation may be required to produce a computer generated holographic virtual image. The data may only be required to include a pixel number to bit pattern pixels (e.g., binary pattern indicia). In some embodiments, a custom display driver may be implemented to perform the pixel value to bit pattern conversion.

In some embodiments, the binary pattern transformation systems and methods described herein are configured to provide a zero-time compute display system. In some embodiments, a binary pattern transformation display uses light to perform the optical lookup from a binary pattern light source input to a light output lookup, which is at the speed of light and becomes effectively instant/zero-time, compared to electrical methods to perform digital memory lookups. Such a system may be used to perform light-speed computation via lookup tables (LUTs) when the light output from the binary transformation display is coupled to a optical sensor such as a Complementary Metal-oxide-Semiconductor (CMOS) sensor chip or some other optical to electrical convertors. In some embodiments, the binary pattern transformation systems and methods described herein allow for no additional power consumption and thermal generation other than input display (i.e., light source array and light source modulation pixels). The transformation layer may be a passive layer of plastic, glass, or other inert material. As such, no electrical power is used for the transformation layer and therefore no additional thermals are generated aside from the light source array and the light source modulation pixels.

In some embodiments, the binary pattern transformation system may also be scalable. In some embodiments, the solution provided by the transformation layer is per pixel and can be formed to work on display sources of any resolution or shape. In one example, a 2-bit binary pattern transformation system could be applied to a standard 16:9 8K LCD display. The native resolution of each Red, Green, Blue sub-pixel in the 8K display would be halved, such that the native 7680×4320 resolution would produce a 3840×4320 2-bit binary transformation display. In some embodiments, one or more layers (e.g., beam shaping, transformation, semi-transparent attenuation, and aperture layers) may be formed on a flexible substrate to form a curved and flexible binary pattern transformation display device. In some embodiments, a binary pattern transformation display can be utilized in micro, medium, and large format displays. For example, a medium sized display may be used in virtual reality (VR) applications to reduce eye box issues, as the binary transformation method is per pixel and therefore has no central optical design in relation to the medium sized display. In addition, a binary transformation display may be used as a multi-focal display in virtual, mixed and augmented reality (VR/MR/AR) applications to reduce the Vergence-Accommodation conflict issue. In another example, a curved binary pattern transformation device may be used for a VR display in place of additional eyepiece optics. In another example, a binary transformation display may be used as a transparent multi-functional display and combiner for augmented reality (AR) applications, wherein the light source array is significantly transparent, the light source modulation pixels, the beam shaping layer, the transformation layers, the attenuation layer, the aperture layer maintain an acceptable level of transparency to light passing through, and produce minimal distortions, such that it can act similar to AR eyeglasses with virtual pixels and real world scenes combined and directly viewable by a user without additional optics. In another example, a binary transformation display may be used for light beam steering applications, where the function of the transformation is to use two or more light beams to form a single light beam at different pre-recorded steering angles for a Light Detection and Ranging (LIDAR) applications.

In some embodiments, the systems and methods described herein provide a pixelated light source array (display, projector, etc.) emitting light from two or more pixels as multiple light sources, the light sources forming a binary pattern impinging onto a first layer, the first layer consisting of one or more materials covering the area of the pixels, performing a light diffraction effect, with the first layer designed to perform a linear or non-linear transformation function of the binary pattern allowing the diffracted light exiting the first layer to form a virtual image based on the transformation function. In some embodiments, one or more additional layers are included after the first layer with the additional layers performing additional diffraction effects and additional transformation of the pixel light. In some embodiments, one or more of the additional layers perform a linear or nonlinear attenuation of the light, wherein the attenuation can optionally attenuate the light one or more pixels, including portions of the entire light source array. In some embodiments, the first layer performs a modification function per pixel; allowing the light from each pixel to be modified, modifications include changing the pixel's light direction, focal point, image formation, intensity profile, phase profile and/or polarization. In some embodiments, the material for the first layer and any additional layers can be composed of transparent, semi-transparent plastic, glass, quartz or any material that allows light transmission, and performs one or combinations of changes to light phase, amplitude, and/or polarization.

In some embodiments, a binary pattern transformation display may be used with an eye or motion-tracking device to provide different views at different viewing angles. For example, when the user is detected to be at a first angle, a first pattern may be used to output a light with a first visual characteristic, and when the user is detected to be at a second angle, a second pattern may be used to output a light with a second visual characteristic, and when the user is detected to be at a third angle, a third pattern may be used to output a light with a third visual characteristic as modified by the transformation layer. In some embodiments, the viewing angle may be quantized to the nearest pre-recorded direction in the binary pattern transformation display. For example, in a 5-bit binary pattern transformation display, thirty-one viewing angles are possible, and the system may select from thirty-one binary patterns to provide one of the thirty-one pre-recorded angles based on the detected location of the viewer. In some embodiments, a laser device includes a laser array configured to form three or more binary patterns and a first layer above the laser array, the first layer comprises a light diffraction material over the laser array. The light diffraction material is configured to steer a first binary pattern formed by the laser array to output a laser beam at a first angle, steer a second binary pattern formed by the laser array to output the laser beam at a second angle, and steer a third binary pattern formed by the laser array to output the laser beam at a third angle.

In some embodiments, a binary pattern transformation display may be used to display different images to multiple viewers based on tracking their individual locations. For three viewers, for example, the 2-bit binary pattern transformation display may be driven to sequentially switch between different patterns such that the visual characteristics of the lights from the display change depending on each viewer's fixed viewing angle. In some embodiments, only one of the viewing angles may have full resolution at one time. In some embodiments, time domain multiplexing (TDM) may be used to sequentially switch between patterns in the binary pattern transformation display, such that multiple viewers receive individual full resolution images.

In some embodiments, a binary pattern transformation display may be used to provide split-screen multi-view for two or more viewers. For example, half of the display may be allocated to a first viewer and the other half to a second viewer and simultaneously display different content to two viewers at two different viewing angles. In some embodiments, the visual characteristics of light from the half of the display allocated to the first viewer may be modified in a way to obscure the display content from the viewing angle of the second viewer and vice versa.

In some embodiments, a binary pattern transformation display may be used as a switchable display. In some embodiments, the transformation layer may comprise an electrically switchable liquid crystal (LC) film encoded with pre-created diffraction patterns to be switched between two states, on and off. For example, in an off state, no pattern exists, and the light passes through with little or no modification. In an on state, the phase and/or amplitude diffraction pattern within the LC film appears to cause light transformation. In some embodiments, a binary pattern transformation device may function as a multi-view and/or multi-focal display as well as function as a mono focal/view display, providing backward compatibility to legacy content. In some embodiments, legacy content images may be pre-processed to include binary pattern values per red, green, blue sub-pixels in addition to or multiplied by the R, G, B intensity values per pixel from the legacy content images for display on a binary pattern transformation display.

In some embodiments, a transformation layer described herein may be used for light beam steering. In some embodiments, light beam steering may be used for LIDAR, time-of-flight (TOF) sensing, laser-based tracking, etc. In some embodiments, the transformation layer may provide passive beam steering by preserving the collimated laser beams from pixel light from a VCSEL array, and change the beam's exit angle from the last transformation layer. In some embodiments, the transformation layers may coalesce the pixel beams from the individual VCSELs in the VCSEL array into one directed beam. For example, 4-bit transformation layers over a 2×2 pixel VCSEL array would provide 15 angles of beam steering, including 7 negative angles, zero angle and 7 positive angles in one axis. In another example, an 8-bit transformation layer or two or more combinations of 4-bit transformation layers could provide 15 angles of two axis, X and Y beam steering.

In some embodiments, a transformation layer described may also be used for laser-based 3D printers. Similar to beam steering, a sufficient bit-depth transformation layer could provide focal distance control over the beam spot to be used for laser-based 3D printers such as a stereolithography (SLA) 3D printer. In some embodiments, a laser 3D printer comprises a laser device for curing a resin to form 3D objects, the laser device comprises a laser array configured to form three or more binary patterns and a first layer above the laser array, the first layer comprises a light diffraction material over the laser array. The light diffraction material is configured to modify a first binary pattern formed by the laser array to output a first laser beam with a beam spot at a first focal distance, modify a second binary pattern formed by the laser array to output a second laser beam with a beam spot at a second focal distance, and modify a third binary pattern formed by the laser array to output a third laser beam with a beam spot at a third focal distance.

In some embodiments, a holographic display system with multiple functional outputs is provided, comprising a pixelated light source array showing binary patterns from two or more pixels, at least one or more layers of light transformation material juxtaposed to the light source array, performing one or more linear or nonlinear transformations of the light source, the linear transformations including one or combinations of diffraction, attenuation or change in polarization, the nonlinear transformation including attenuation and/or wavelength conversion, the combination of one or more layers of light transformation to perform a function, the function include forming one or more virtual pixels at a certain focal distance, position, orientation, color, intensity and polarization juxtaposed to the light source array. In some embodiments, the pixelated light source array comprises of a LED-backlit LCD display. In some embodiments, the pixelated light source array comprises one or more VCSELs as the light sources to the binary pixels. In some embodiments, the light transformation material consists of a substantially transparent material containing variable thickness, variable sized bumps to perform phase-based diffraction. In some embodiments, the light transformation material consists of a substantially transparent material covered with an opaque film with a pattern to perform amplitude-based diffraction. In some embodiments, the material is made from Poly Methyl Methacrylate (PMMA) Acrylic plastic. In some embodiments, the material is made from Soda Lime Glass covered with an opaque metallic Chrome patterned film. In some embodiments, the function of the display is to show a virtual image at different focal depths. In some embodiments, the function of the display is to show a different virtual image at different viewing angles.

In some embodiments, one or more of the embodiments, methods, approaches, schemes, and/or techniques described above may be implemented in one or more computer programs or software applications executable by a processor-based apparatus or system. By way of example, such processor-based system may comprise a smartphone, tablet computer, virtual reality (VR), augmented reality (AR), or mixed reality (MR) system, entertainment system, game console, mobile device, computer, workstation, gaming computer, desktop computer, notebook computer, server, graphics workstation, client, portable device, pad-like device, communications device or equipment, etc. Such computer program(s) or software may be used for executing various steps and/or features of the above-described methods, schemes, and/or techniques. That is, the computer program(s) or software may be adapted or configured to cause or configure a processor-based apparatus or system to execute and achieve the functions described herein. For example, such computer program(s) or software may be used for implementing any embodiment of the above-described methods, steps, techniques, schemes, or features by generating content for and/or driving a display device described herein. As another example, such computer program(s) or software may be used for implementing any type of tool or similar utility that uses any one or more of the above-described embodiments, methods, approaches, schemes, and/or techniques. In some embodiments, one or more such computer programs or software may comprise a VR, AR, or MR application, communications application, object positional tracking application, a tool, utility, application, computer simulation, computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods, schemes and/or techniques. In some embodiments, such computer program(s) or software may be stored or embodied in a non-transitory computer readable storage or recording medium or media, such as a tangible computer readable storage or recording medium or media. In some embodiments, such computer program(s) or software may be stored or embodied in transitory computer readable storage or recording medium or media, such as in one or more transitory forms of signal transmission (for example, a propagating electrical or electromagnetic signal).

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, schemes, and/or techniques described herein for generating content for or driving a binary pattern transformation display device. For example, in some embodiments the present invention provides one or more non-transitory computer readable storage mediums storing one or more computer programs adapted or configured to cause a processor-based apparatus or system to execute steps comprising any one or more of the embodiments, methods, approaches, schemes, and/or techniques described herein for generating content for or driving a binary pattern transformation display device.

While the invention herein disclosed has been described by means of specific embodiments and applications thereof, numerous modifications and variations could be made thereto by those skilled in the art without departing from the scope of the invention set forth in the claims.

What is claimed is:

1. A display device comprising:
a display array comprising a plurality of binary pixels, each binary pixel comprises:
at least one light source;
at least two light source modulating pixels configured to form three or more binary patterns;
a first layer above the at least two light source modulating pixels, the first layer comprises a light diffraction material over the binary pixel;
wherein the light diffraction material is configured to:
cause a first modification of a first binary pattern to output a first light;
cause a second modification of a second binary pattern to output a second light; and
cause a third modification of a third binary pattern to output a third light; wherein at least the first light, the second light and the third light have different visual characteristics.

2. The display device of claim 1, wherein the first layer comprises two or more regions of different thicknesses having variable refractive index configured to cause diffractions from different phase-based modulations.

3. The display device of claim 1, wherein the first layer comprises a variable-sized aperture patterned mask configured to cause different diffractions from amplitude-based modulations.

4. The display device of claim 1, wherein the first layer comprises a volume hologram material configured to cause different diffractions from phase modulations and/or amplitude modulations.

5. The display device of claim 1, wherein the third light is formed by optical interference of the light from at least a first light source modulating pixel and a second light source modulating pixel.

6. The display device of claim 1, wherein the first modification and the second modification comprise different optical transformations.

7. The display device of claim 1, wherein the first light, the second light, and the third light differ in one or more of light direction, focal point, intensity profile, phase profile, image formation, wavelength and/or polarization.

8. The display device of claim 1, further comprising:
a second layer of light diffraction material configured to cause secondary diffraction of light passing through the first layer.

9. The display device of claim 1, further comprising:
one or more of additional layers configured to cause an attenuation of light passing through the first layer.

10. The display device of claim 1, further comprising: a beam shaping layer between the first layer and the at least two light source modulating pixels, and/or
an aperture layer configured to block light around peripheral edges of each of the at least two light source modulating pixels.

11. The display device of claim 1, wherein the first layer comprises transparent or semi-transparent plastic, glass, and/or quartz.

12. The display device of claim 1, wherein the at least two light source modulating pixels are from a light-emitting diode (LED) backlit liquid crystal display (LCD).

13. The display device of claim 1, wherein the at least two light source modulating pixels are from a vertical-cavity surface-emitting laser (VCSEL) backlit liquid crystal display (LCD).

14. The display device of claim 1, wherein the light diffraction material comprises Poly Methyl Methacrylate (PMMA) Acrylic plastic.

15. The display device of claim 9, wherein the light diffraction material comprises soda lime glass covered with an opaque patterned film.

16. The display device of claim 1, wherein the plurality of binary pixels is configured to form a virtual image with pixels having a plurality of focal depths.

17. The display device of claim 1, further comprising a processor configured to drive the at least two light source modulating pixels based on an input image comprising pixels that are binary patterns of quantized depth values attenuated by the intensity of the pixel for a corresponding color.

18. The display device of claim 1, further comprising a processor configured to identify a viewing angle of a viewer and select binary patterns for each binary pixel based on the viewing angle.

19. The display device of claim 1, wherein the plurality of binary pixels is configured to simultaneously display two or more different virtual images to viewers at different viewing angles.

20. The display device of claim 1, wherein the first layer comprises a switchable liquid crystal film configured to switch between an on state and an off state, wherein in the off state, the first layer does not cause the first, second or third modifications to the binary patterns.

21. A method for displaying an image comprising:
driving the display device of claim 1 with a signal comprising binary pattern indicia for the plurality of binary pixels.

22. A method, comprising:
establishing a layer comprising a light diffraction material;
using the layer to create a first output light by causing a first modification of a first binary pattern formed by light from at least two light source modulating pixels;
using the layer to create a second output light by causing a second modification of a second binary pattern formed by light from the at least two light source modulating pixels; and
using the layer to create a third output light by causing a third modification of a third binary pattern formed by light from the at least two light source modulating pixels; wherein at least the first output light, the second output light and the third output light have different visual characteristics.

23. The method of claim 22, wherein the first modification, the second modification and the third modification comprise different optical transformations.

24. The method of claim 22, further comprising:
using an additional layer of light diffraction material in forming the first output light, the second output light, and the third output light.

25. The method of claim 24, wherein the additional layer of light diffraction material is configured to cause secondary diffraction of light passing through the layer.

26. A laser device comprising:
a laser array configured to form three or more binary patterns; and
a first layer above the laser array, the first layer comprises a light diffraction material over the laser array;
wherein the light diffraction material is configured to:
steer a first binary pattern formed by the laser array to output a laser beam at a first angle;
steer a second binary pattern formed by the laser array to output the laser beam at a second angle; and
steer a third binary pattern formed by the laser array to output the laser beam at a third angle.

27. The laser device of claim 26, wherein the laser array comprises a vertical-cavity surface-emitting laser (VCSEL) array.

28. The laser device of claim 26, wherein the light diffraction material is further configured to coalesce beams from a plurality of lasers of the laser array into one beam.

29. The laser device of claim 26, wherein the laser device is a light source of a LIDAR, a time-of-flight sensor, or a laser-based tracking device.

30. A laser based three-dimensional (3D) printer comprising:
a laser device for curing a resin to form 3D objects, the laser device comprises a laser array configured to form three or more binary patterns; and
a first layer above the laser array, the first layer comprises a light diffraction material over the laser array;
wherein the light diffraction material is configured to:
modify a first binary pattern formed by the laser array to output a first laser beam with a beam spot at a first focal distance;
modify a second binary pattern formed by the laser array to output a second laser beam with a beam spot at a second focal distance; and
modify a third binary pattern formed by the laser array to output a third laser beam with a beam spot at a third focal distance.
